(19) United States
(12) Patent Application Publication
(10) Pub. No.: US 2025/0058589 A1
(43) Pub. Date: Feb. 20, 2025

(54) Tire Having a Compromise in Terms of Performance Between Grip on Snow and Running Noise

(71) Applicant: COMPAGNIE GENERALE DES ETABLISSEMENTS MICHELIN, Clermont-Ferrand (FR)

(72) Inventors: Clément ORAMBOT, Clermont-ferrand Cedex 9 (FR); Nicolas HEROLD, Clermont-ferrand Cedex 9 (FR)

(21) Appl. No.: 18/722,183

(22) PCT Filed: Dec. 9, 2022
(86) PCT No.: PCT/EP2022/085110

§ 371 Date: Jun. 20, 2024

(30) Foreign Application Priority Data
Dec. 20, 2021 (FR) FR2113958

(51) Int. Cl. B60C 11/03; B60C 11/12

(52) U.S. Cl. CPC B60C 11/0318; B60C 11/0302; B60C 11/1236

(57) ABSTRACT

A tire (1) having a tread (10) with from one to three tread pattern elements (MA, MB, LC) distributed over one revolution of a wheel. Each tread pattern element has first and second portions positioned on either side of an equatorial plane (C). Each portion of each tread pattern element has at least one main sipe (85) having the curvature of said portion, and substantially parallel to its edges, the main sipe (85) extends continuously from a first axial edge (24G, 24D) on a first side of the equatorial plane (C) to a connection point (90) situated in a main void (80) on a second side of the equatorial plane (C), the main void (85) extending to a second edge (24G, 24D) of the tread (10); the axial width of the main sipe (85) represents from 52% to 63% of the axial width of the tread (10).

### TECHNICAL FIELD

The present invention relates to a tire for a motor vehicle, and more particularly to an “all-season” tire intended to be fitted to a passenger vehicle or a van.

In a known manner, a tire known as an “all-season” tire for a passenger vehicle or a van has a compromise in terms of grip on snow-covered and wet ground while preserving performance on dry ground. These tires aim to run safely all year round regardless of the weather. They have generally received the regulatory winter certification 3PMSF (3 Peaks Mountain Snow Flake), according to regulations related to tire safety such as UNECE (United Nations Organization for the European Economic Committee) regulations R30/R54 and R117 attesting to their approved grip performance on snow-covered and wet ground.

This certification is indicated on one or both sidewalls of these types of tires by a distinctive logo representing a mountain with three emerging peaks comprising a snowflake (3 Peaks Mountain Snow Flake: 3PMSF).

The invention also relates to multipurpose tires that can be used in different meteorological conditions, without thereby having the performance of a 3PMSF tire, and that have an “M+S” (Mud+Snow) marking on at least one of their sidewalls.

The term “grip” is understood to mean both the grip characteristics of the tire in the direction transverse to the movement of the vehicle, such as cornering behaviour, and those of the tire in the direction longitudinal to the movement of the vehicle, i.e. the possibility of transmitting a braking or driving force to the ground.

### Definitions

In what follows, the circumferential, axial and radial directions respectively designate a direction tangential to any circle centred on the axis of rotation of the tire, a direction parallel to the axis of rotation of the tire and a direction perpendicular to the axis of rotation of the tire.

By convention, a reference frame (O, XX′, YY′, ZZ′), with the centre O coinciding with the centre of the tire, the circumferential XX′, axial YY′ and radial ZZ′ directions respectively designate a direction tangent to the tire tread surface in the direction of rotation, a direction parallel to the axis of rotation of the tire, and a direction orthogonal to the axis of rotation of the tire.

By “radially inner” or “radially outer” respectively is meant closer to or farther from the axis of rotation of the tire, respectively.

By “axially inner” or “axially outer” respectively is meant closer to or farther from the equatorial plane of the tire respectively, the equatorial plane of the tire being the plane passing through the middle of the tire tread and perpendicular to the axis of rotation of the tire.

A tire comprises a crown, intended to come into contact with the ground via a tread, the two axial ends of which are connected by means of two sidewalls to two beads ensuring the mechanical connection between the tire and the rim on which it is intended to be mounted.

The term “tread surface” is understood to mean the surface which groups together all the points of the tire which will come into contact with the ground under normal running conditions. These points that will come into contact with the ground belong to the contact faces of the blocks. For a tire, the “normal running conditions” are the use conditions defined by the ETRTO (European Tire and Rim Technical Organisation) standard. These use conditions specify the reference inflation pressure corresponding to the load-bearing capacity of the tire as indicated by its load index and its speed rating. These use conditions can also be referred to as “nominal conditions” or “working conditions”.

The total tread width is the axial distance between the axial ends of the tread surface distributed on either side of the equatorial plane of the tire. From a practical standpoint, an axial end of the tread surface does not necessarily correspond to a point that is clearly defined. In the knowledge that the tread is delimited externally, on the one hand, by the tread surface and, on the other hand, by two connecting surfaces where it meets two sidewalls that connect said tread to two beads intended to provide the connection to a mounting rim, an axial end can therefore be defined mathematically as being the orthogonal projection, onto the tread, of a theoretical point of intersection between the tangent to the tread surface in the axial end zone of the tread surface and the tangent to the connecting surface in the radially outer end zone of the connecting surface. The total width of the tread corresponds substantially to the axial width of the contact surface when the tire is subjected to the recommended load and pressure conditions.

A circumferential plane is a plane orthogonal to the axis of rotation of the tire, and the equatorial plane is the circumferential plane passing through the axial centre of the tread.

The tread is usually formed by the repetition of raised volumetric elements called tread pattern elements in the circumferential direction which are separated from one another by cuts. A tread pattern groups together a collection of raised elements, from a first axial end of the tread to a second axial end.

The pitch of a tread pattern element is the distance measured along a circumference of the tire between a point on that element and the translated image of that point on the immediately following element in the direction of rotation of the tire.

A tread with a single tread pattern element is known as a mono-pitch tread. However, in general, the tread of a passenger vehicle tire consists of a circumferential repetition of two or three tread pattern elements with pitch lengths comprised between 20 mm and 50 mm. In general, two consecutive tread pattern elements are homothetic.

In order to increase the grip potential of a tread of a tire running on a snow-covered or water-covered road, it is known to provide this tread with a tread pattern formed by a plurality of cuts made more or less deeply in each tread pattern element, said cuts opening onto the tread surface in contact with the road.

A cut is understood to mean any void made in the tread, whether by removing material once the tread has been vulcanized or by moulding in a mould for moulding said tread and comprising moulding elements projecting from the moulding surface of said mould, each moulding element having a geometry identical to the geometry of the desired cut. As a general rule, a cut made in a tread is delimited by at least two walls of rubber that face one another, said walls being separated by a mean distance representing the width of the cut, the intersection of said walls with the tread surface forming edge corners. A distinction is made between several types of cuts, for example:
grooves or channels which are characterized by a width greater than approximately 10% of the thickness of the tread;
sipes, the width of which is relatively small compared with the thickness of the tread; under certain loading conditions, these sipes may at least partially close in the contact patch in which the tire is in contact with the road; the opposing walls come into contact with one another over a greater or lesser proportion of the surface area of said walls (the edge corners formed by a sipe on the tread surface are in contact with one another, thus closing the sipe). In general, the distance between the walls of material that delimit a sipe is less than or equal to 2 mm and the depth is greater than or equal to 1 mm.

Some cuts may open into at least one other cut. The path of a cut along the tread surface of a tread follows a mean geometric profile which is determined as being the geometric profile situated at a mean distance from the edge corners formed by the walls of said cut on the tread surface. The mean axis of the path of a cut on the tread surface corresponds to the straight line of least squares of the distances of the points of the mean profile of the path of said cut.

By making a plurality of cuts that open onto the tread surface, a plurality of edge corners of rubber that bite into the layer of water that may be present on the road are created, so as to keep the tire in contact with the ground and to create cavities possibly forming channels intended to collect and evacuate the water present in the contact patch in which the tire is in contact with the road, provided that these cavities are arranged so as to emerge outside of the contact patch.

### PRIOR ART

One example of such a tread pattern is found in U.S. Pat. No. 1,452,099, which describes a tread provided with a plurality of regularly spaced transversely oriented sipes.

However, the increase in the number of cuts rapidly leads to a substantial reduction in the stiffness of the tread, which has an unfavourable effect on the performance of the tire or even on the grip performance. What is meant by the stiffness of the tread is the stiffness of the tread under the combined actions of compression loading and shear loading in the region affected by contact with the road. At the same time, the presence of numerous cuts forming water discharge channels leads to a level of tire noise, when running on a dry road, which is nowadays considered to be unacceptably high, and which it is desirous to reduce as much as possible, particularly on vehicles of recent design. This tire noise is amplified by the cyclic movements of opening and closing of the cuts as well as the rubbing-together of the walls of said cuts when these cuts are closed.

Patent FR 1028978 proposes a solution to this problem which consists in providing the tread with a plurality of circumferential sipes of shallow depth on the tread surface of the new tread so as to increase the flexibility of said tread in the vicinity of the tread surface alone.

However, since the tire is intended, once mounted on a vehicle, to ensure good performance throughout the life of said tire (i.e. up to wear of its tread corresponding at least to the legal level permitted), it is necessary to provide a tread whose tread pattern ensures the durability of the grip performance on wet and snow-covered ground.

The object of the present invention is to develop a tire with a tread which combines both a very good level of grip on snow-covered and/or wet roads throughout the life of said tire, and which creates tire noise that meets the regulations.

### SUMMARY OF THE INVENTION

According to the invention, what is proposed is a tire comprising a tread intended to come into contact with the ground via a tread surface:
the tread comprising raised elements organized into at least a first and a second tread pattern element, at least partially separated from one another by grooves and extending radially outwards from a bottom surface to the tread surface over a radial height H at least equal to 6 mm and at most equal to the radial thickness Hₛᵣₑ of the tread;
each tread pattern element comprising a first portion arranged on a first side of the equatorial plane passing through the centre of the tread, said first portion extending continuously into a second portion arranged on a second side of the equatorial plane;
the tread being obtained by repeating over one revolution of the wheel the first tread pattern element formed by a first and a second portion according to a first pitch PA, and the second tread pattern element MB formed by a first and a second portion according to a second pitch PB, with PA<=PB;
each portion being a volumetric element having leading faces which are the faces of which a radially outer edge corner enters the contact patch first when the tire passes over the ground;
PSI2 being the angle formed by each leading face of a portion with an axial direction, defined by the axis of rotation of the tire, PSI2 being comprised in the range [0°; 60° ];
each portion of each tread pattern element comprises at least one main sipe having the curvature of said portion, and substantially parallel to its edges, said main sipe extends continuously from a first axial edge on a first side of the equatorial plane to a connection point situated in a main void on a second side of the equatorial plane, said main void extending to a second edge of the tread; the axial width of said main sipe represents from 52% to 63% of the axial width of the tread; said connection point is situated at a distance normal to the equatorial plane comprised between [0, 25] mm; the angle PSI2 of each leading face of a tread pattern portion is comprised in the range [25°; 60° ] at the axially inner end of the main void.

At the outset, it is necessary to distinguish between the main voids and sipes that differ from the other voids and sipes of the tread pattern that may be circumferential, axial or oblique. An oblique void or sipe means that they have both an axial and circumferential component. The main sipes, each extended by a main void, are positioned on a tread pattern element whose curvature they follow. Their depth, width and orientation distinguish them in their contribution to the grip of the tire on snow-covered, wet or dry ground. Each tread pattern element contains at least two main sipes and voids that extend across the whole width of the tread from one edge to the other.

The principle of the invention is to position at least one main sipe extended by a main void on each tread pattern element, from a first axial end to the centre of the tread to improve grip on wet and snow-covered ground. The inventors have observed that the invention gives improved results with respect to the usual designs of treads when the length of the main void and that of the main sipe are as wide as possible through the tread. On snow-covered ground, the edge corners of the main voids are favourable to traction, and the flexibility of the tread pattern provided by the main sipes is also beneficial for snow grip, but is especially suitable for grip on wet ground. On each tread pattern element, the distribution of the length of the main void compared to that of the main sipe shifts the compromise between grip on snow and on wet ground.

A main feature of the invention is that the connection point is situated at a distance normal to the equatorial plane comprised between [0, 25] mm. This condition ensures the presence of a circumferential rib towards the centre of the tread. In other words, the voids do not open out between them towards the centre of the tread. This results in a noticeable improvement in tire noise compared with configurations in which the voids are contiguous and create acoustic resonance.

Each main sipe extends beyond the equatorial plane at a connection point situated in a void. There is therefore a continuity of cut through the tread, which makes the tread more flexible, thus promoting the flattening of the tire by the circumferential and axial flexing.

The angle PSI2 determines the orientation of the leading face when entering the contact patch, and its effect on snow grip is optimal when the direction of the leading face varies between 0° and 60° with respect to the axial direction, and more precisely between 25° and 60° for the leading faces situated at the axially inner end of the main void.

To be truly effective, the main sipe extended by the main void must be sufficient in number in the contact patch. According to the inventors, each tread pattern element may contain several main sipes each extended by a main void. Another solution to increase the main voids and sipes is to increase the number of tread pattern elements per wheel revolution. In the latter case, the impact on tire noise must be taken into account.

In the search for a compromise between tire noise performance and grip performance on snow-covered or wet ground, the main sipes and voids of the invention are defined in a correlated manner with the tread pattern elements.

For this purpose, the tread pattern is designed from a basic pattern element MA which comprises raised elements extending from a first axial end of the tread to a second axial end. A pitch PA is associated with this tread pattern element. A second tread pattern element MB with an associated pitch PB is deduced from MA by homothety, at least as regards the geometric shape of the tread pattern elements. Starting out from the positioning of a first tread pattern element on the crown of the tire, and travelling a circumferential distance corresponding to the associated pitch, a homothetic second tread pattern element is positioned after the first tread pattern element. By running this algorithm over one revolution of the wheel, a tread is obtained that is made up of a succession of homothetic tread pattern elements. Two tread pattern elements may differ in terms of their circumferential width, their sipe density and/or the associated pitch. According to the inventors, two to three tread pattern elements (MA, MB, MC) are sufficient to significantly attenuate the tire noise. Beyond three tread pattern elements, the cost of manufacturing the tire curing mould becomes prohibitive.

In the case where the tread pattern elements and pitches are identical, the configuration is a mono-pitch tread pattern configuration which corresponds to the particular solution of the invention.

According to the inventors, there is a distinction between two major types of features that are caused by the impact of the tread pattern elements on the roadway: whining and beating. These are features of which the acoustic power is much greater than the mean power of the spectrum and to which the human ear is particularly sensitive.

The timing of the impacts of the tread pattern on the ground on entering the contact patch is given its pattern by the order of succession of the tread pattern elements. If the tread pattern elements are all the same size, they follow one another with a perfectly regular rhythm. One single frequency will then be brought about, and this will produce a “whine”-like sound. Having several sizes of tread pattern element makes it possible to scramble the sound signal emitted by the tread pattern of the tire, that is to say to reduce the features, so as to tend towards white noise.

The succession of tread pattern elements is designed to attenuate whining and beating. Thus, designing the tread pattern on the basis of homothetic tread pattern elements makes it possible to control the level of noise emitted by the tire during running.

All of the features of the invention contribute to obtaining the tire of the invention, characterized in that it achieves a compromise in terms of performance in grip on snow while having a tire noise level in accordance with the regulatory requirements, by virtue of the main sipes each extended by a main void in suitable quantity and orientation.

Other features of the invention related to the number of tread pattern elements, their distribution over one revolution of the wheel, or their geometry reinforce the technical solution in terms of its tire noise level achieved.

Preferably, the tread comprises a third tread pattern element MC formed of two tread pattern portions (MC1, MC2), distributed on either side of the equatorial plane, and of pitch PC, with PB less than PC, such that the ratio of the pitches PB/PC is greater than or equal to the ratio of the pitches PA/PB.

The addition of a third tread pattern element requires a new optimization of the tire noise compared with a solution with only two tread pattern elements. According to the inventors, the pitch of this third tread pattern element is not chosen randomly: it must obey a relation of proportionality with the pitches of the two already existing tread pattern elements. This requirement on the pitches leads to an attenuation of the tire noise compared with the solution with only two pitches.

Once the pitch of the third tread pattern element has been defined, it is necessary to distribute the three tread pattern elements over one revolution of the wheel, and to define their geometric shape.

Advantageously, each first portion on a first side of the equatorial plane and each second portion on a second side of the equatorial plane are curved in an axial direction from an axial end of an edge of the tread to its centre.

The solution adopted for the geometry of the tread pattern elements consists in curving them in the axial direction so as to create edge corners of voids and sipes generally orthogonal to the direction of advance of the tire. In doing so, the edge corners of the voids help improve traction performance on snow. This performance is amplified when, preferably, each first portion on a first side of the equatorial plane and each second portion on a second side of this same equatorial plane is curved in an axial direction from an axial end of an edge of the tread to its centre so as to give the tread pattern elements a “V” shape (or a chevron shape), thus defining a preferred direction of running of the tire in the direction of the “V” tip (or chevron tip).

With a view to simplifying industrial implementation, in particular during the manufacture of the curing moulds, advantageously each first portion on a first side of the equatorial plane and each second portion on a second side of this same equatorial plane are symmetrical with respect to this same equatorial plane.

Other features linked to different embodiments of the invention contribute to still further improving the grip performance of the tire. Most often, these features relate to the geometry of the main voids and sipes, their orientation or their depth and width in each tread pattern element.

Advantageously, the ratio of the axial length of a main sipe divided by the axial length of a main void is comprised in the range [1.1; 1.6].

The proportion of the relative length of a main void and of a main sipe is a lever for positioning the desired performance compromise. The presence of main voids promotes traction, and therefore traction in snow, and the presence of main sipes in the width of the tread is favourable to tire noise.

A main sipe may be of complex shape in order to achieve the performance compromise; advantageously, at least one main sipe contains an internal channel buried in the thickness of the tread which is revealed with wear of the tire. This feature is a solution for prolonging the life of the tire.

Preferably, for better functioning of the invention, the radial depth of a main sipe of a tread pattern element is comprised between 20% and 80%, and preferably between 30% and 50%, of the maximum radial height of the tread pattern measured radially from the bottom of the tread pattern. Such a feature is required to give a tire winter traction regardless of the level of wear. The width of a main sipe is defined as being the normal distance between the two walls of said main sipe; in the context of this invention, this width is comprised between 0.3 mm and 2 mm, preferably between 0.4 mm and 1 mm. The effect associated with this feature is to allow the main sipes to be blocked in the contact patch on dry ground and thus to obtain a better performance in terms of wear rate.

The inventors also framed the geometry of the main voids in order to optimize the results of the invention. The width of a main void of a tread pattern portion is defined as being the normal distance between the two walls of said main void. Advantageously, the width of a main void of a tread pattern portion is comprised between 5 mm and 13 mm, and preferably between 5 mm and 9 mm, in order to avoid the retention of large stones damaging the tread. The radial depth of a main void is comprised between 80% and 100% of the maximum radial height of the tread pattern, measured radially from the bottom of the tread pattern, to allow sufficient drainage of water on wet ground.

The inventors have identified characteristics related to the cuts of the tread, to its volumetric and area voids ratios.

The overall volumetric voids ratio TEV corresponds to the ratio of the voids volume VE to the total volume VT of the tread, such that TEV=VE/VT. Advantageously, the overall volumetric voids ratio TEV of the tread is comprised between [20%; 30%], and preferably between [20%; 35%].

For grip performance on snow-covered ground, the voids ratio has a rack effect to promote the grip of the tire in snow. This rack effect is amplified with a directional tread pattern comprising cuts. According to the inventors, an overall voids ratio TEV comprised between [20%, 40%] and preferably between [20%, 35%] is necessary in order to have a performance of grip on snow that is in accordance with expectation.

In addition, the volumetric voids ratio also defines the volume of elastomeric material constituting the tread that is intended to be worn. The voids ratio is therefore a sensitive parameter for determining the compromise of the performance aspects of the tire such as wear, grip and noise.

In addition to the volumetric voids ratio, the area voids ratio is another determining criterion for the desired performance compromise. The tread forms a contact patch AC with the ground during the running of said tire, a portion of the tread pattern elements also forming a contact surface SC on said contact patch AC. The area voids ratio TES of the tread is defined as being the ratio, TES=A_{c}-s_{c}/A_{c} Preferably, TES is comprised in the range [0.35; 0.6], and more preferably TES is at least equal to 0.38, and even more preferably TES is at least equal to 0.4.

The inventors have identified other characteristics related to the pitches of the tread pattern elements to even better manage the compromise between the grip and the tire noise.

Preferably, the ratio between the pitch PA of the first tread pattern element MA divided by the pitch PB of the second tread pattern element MB, PA/PB is at least equal to 0.60 and at most equal to 0.90.

The ratio PA/PB of the shortest pitch PA of the first tread pattern element divided by the longest pitch PB of the second tread pattern element is comprised in the range [0.6; 0.9]. The smallest pitch and the longest pitch are in a ratio ideally equal to 0.85, or at least included in the range [0.6; 0.9].

When the pitch ratio is less than 0.6, the difference between the two pitches becomes too large and causes too great a discontinuity in the arrangement of the tread pattern elements over one revolution of the wheel.

Conversely, for a pitch ratio beyond 0.9, the distance between the tread pattern elements becomes too small, the tread pattern becomes close to a mono-pitch solution which is not satisfactory as regards the level of noise generated.

Advantageously, the volumetric voids ratio TEM of each tread pattern element (MA, MB, MC) is substantially identical. By following the same principle of defining the overall volumetric voids ratio TEV, a volumetric voids ratio of a tread pattern element TEM can be defined. The tread pattern is designed so as to have homogeneity of the stiffnesses over one revolution of the wheel by a uniform distribution of the volumes of material.

In the design of a snow tire tread, the choice of tread material is an essential step. The chemical composition of the tread material is formulated to remain flexible at a low temperature, which increases grip on slippery (wet, snowy and icy) ground. What is meant by low temperature is a temperature of below 7° C.

Advantageously, the composition of the rubber material of the tread has a glass transition temperature Tg comprised between −40° C. and −10° C. and preferably between −35° C. and −15° C. and a complex dynamic shear modulus G* measured at 60° C. comprised between 0.5 MPa and 2 MPa, and preferably between 0.7 MPa and 1.5 MPa.

The grip of the tire on the ground obeys at least two physical phenomena: grip and indentation. For example, for wet ground, the tread pattern of the tread evacuates water from the ground to provide grip by means of the dry tread surface sticking to the ground. In parallel, the flexibility of the material of the tread makes it possible to conform to the irregularities of the ground by indentation in order for the tire to hold the road. The material needs to remain flexible and effective at temperatures below 7° C. According to the inventors, an elastomeric material having a glass transition temperature Tg comprised between −40° C. and −10° C. and preferably between −35° C. and −15° C. and a complex dynamic shear modulus G* measured at 60° C. comprised between 0.5 MPa and 2 MPa, and preferably between 0.7 MPa and 1.5 MPa, gives the tread the appropriate physical properties to achieve the desired performance compromises.

The tire of the invention, on account of its tread pattern and the material of the tread, passed the snow grip test required to have the 3PMSF (3 Peaks Mountain Snow Flake) certification indicated on at least one of its sidewalls.

### BRIEF DESCRIPTION OF THE DRAWINGS

The present invention will be better understood on reading the detailed description of embodiments given by way of non-limiting examples and illustrated by the appended drawings, in which:

FIG. 1-A represents a view of the tire of the invention in a meridian plane.

FIG. 1-B shows a developed view of the tread which covers the tire of FIG. 1-A.

FIG. 2-A shows a first tread pattern element MA composed of two portions MA1 and MA2 arranged on either side of an axial plane passing through the centre of the tread.

FIG. 2-B illustrates the principle of construction of the tread from tread pattern elements (MA, MB) composed respectively of portions (MA1, MA2) and (MB1, MB2). In FIGS. (2-A, 2-B), the equatorial plane passing through the centre of the tread is referenced C.

FIG. 2-C is an illustration of the angle PSI2 made by the mean plane of a leading face with the circumferential direction XX′. This figure also shows cuts other than the main sipes and voids.

FIG. 3 shows a developed view of the tread in the circumferential direction (X) according to one embodiment of the invention, with three tread pattern elements MA, MB and MC. The tread pattern elements differ in terms of their geometry (widths, cuts, pitches, etc.). The tread pattern element MA is represented with a light grey background, the tread pattern element MB with small waves, and the tread pattern element MC with a background with black dots. As in FIG. 2-B for the tread pattern element MB, the tread pattern element MC comprises two portions MC1 and MC2.

### DETAILED DESCRIPTION OF THE INVENTION

The invention has been more particularly studied for a passenger car tire of standardized designation, according to the ETRTO (European Tire and Rim Technical Organisation) specifications standard, 245/35 R20 XL 95V. For this dimension, a version of the tire according to the invention with a tread comprising three tread pattern elements MA, MB and MC with respective variable pitches PA, PB and PC was produced.

In the various figures, elements that are identical or similar bear the same references. For the legibility of the figures, the elements are referenced once only, sometimes on the side 24G, sometimes on the side 24D.

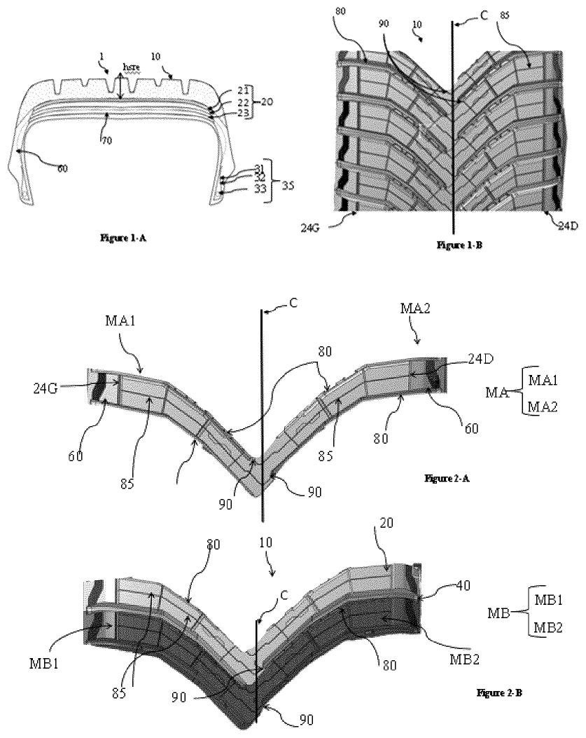

FIG. 1-A gives a view in a meridian plane of the tire, of general reference 1, showing the height of the tread pattern of the tread 10 which rests on the crown 20 comprising the crown layers (21, 22, 23), firstly a hooping layer 21 radially inwardly of the tread, then two crossed layers (22, 23) representing the working layers, radially inwardly of the hooping layer 21. The tire 1 also comprises a carcass reinforcement 70 consisting of reinforcers coated in a rubber composition, and two beads 35 intended to be in contact with a rim. Said carcass reinforcement 70 connects the two beads 35 and comprises a main branch 31 which is wrapped around an annular reinforcing structure 33 to form a turnup 32. The sidewalls 60 connect the beads 35 to the tread 10. In FIG. 1-B, the tread 10 which is shown covers the tire of FIG. 1-A radially outside the hooping layer 21. A void 85 on a first side of the equatorial plane (C), initiated from a first edge (24G, 24D) of the tread 10, passes through a connection point 90 to be extended in a void 80 which terminates in a second edge (24G, 24D).

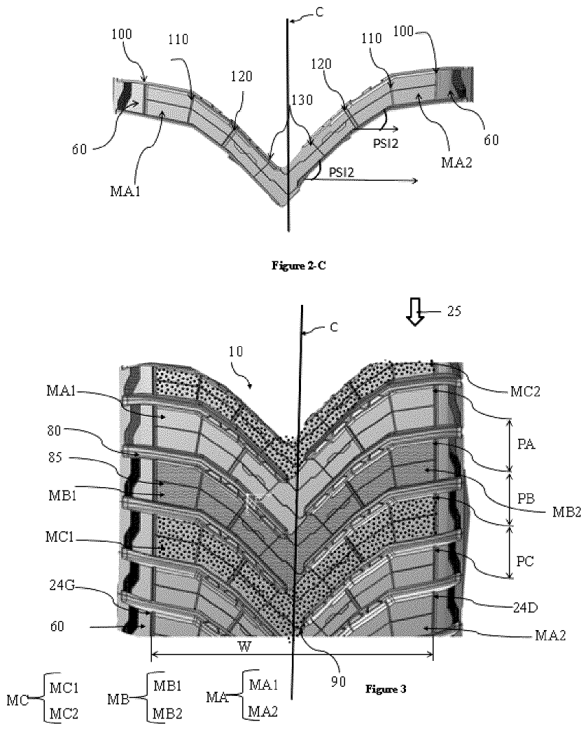

FIG. 2-A shows a first tread pattern element MA composed of the portions MA1, MA2 arranged on either side of the equatorial plane C. The main sipes 85 are positioned all along a first portion of the tread pattern element MA up to a connection point 90 situated in a main void 80 which extends to an axial end (24D, 24G) of the tread 10. For the tire size being studied, the pitch PA is equal to 24.9 mm.

FIG. 2-B shows a second tread pattern element MB. MB is derived from MA by homothety, at least in terms of its geometry. However, the number of cuts between the two tread pattern elements may be different. For the tire size studied, the pitch PB is equal to 29.3 mm. The third tread pattern element MC is defined in the same way as MB and for its part is also composed of two portions MC1 and MC2, arranged on either side of the equatorial plane. In the example studied here, the pitch PC is equal to 35.6 mm.

In order to optimize the arrangement of the tread pattern elements, that is to say their succession over one revolution of the wheel so as to reduce the whining and beating noise, an elementary signal, for example a sinusoidal signal, is associated with each tread pattern element. For one complete revolution of the wheel, the associated signal is periodic and results from the sum of the elementary signals.

With the help of a numerical tool, the optimization of the initial arrangement with respect to the whining and beating noise is carried out by performing simulations on different possible arrangements. Using a Fourier transform on the signal associated with the arrangement, the spectrum of the signal is analysed in the frequency domain. The criteria for stopping the optimization process are linked to the amplitude of the whining and beating features, and to their spread along the frequency axis.

Following this iterative approach, for the tire size studied, 235/65R16 115/113R, the total number of tread pattern elements is 76 over one revolution of the wheel, arranged according to the sequence: MA MC MB MC MC MC MA MA MA MA MA MC MC MC MB MC MA MC MA MA MA MB MA MC MA MA MA MC MB MB MB MB MB MA MA MB MC MB MB MB MA MB MC MB MC MC MB MA MA MA MB MA MB MB MB MC MC MB MA MB MC MB MC MB MB MA MA MB MC MA MA MA MA MA MA MC.

The circumference of the tire is equal to 2225 mm, and the width of the tread is 190 mm. The tread pattern of the manufactured tire comprises 3 tread pattern elements (MA, MB, MC) divided into 30 tread pattern elements MA, 25 tread pattern elements MB and 21 tread pattern elements MC.

The following table summarizes the characteristics of the tread pattern elements (MA, MB):

TABLE 1

| | Number of | Pitch | Tread block | Area voids | Volumetric |
|---|---|---|---|---|---|
| | elements | (mm) | width | ratio | voids ratio |
| Element MA | NA = 30 | 24.9 | 18.1 | 41 | 24.2 |
| Element MB | NB = 25 | 29.3 | 21.6 | 39 | 24.2 |
| Element MC | NC = 21 | 35.6 | 26.3 | 38 | 24.2 |

The volumetric voids ratio of each tread pattern element (MA, MB, MC) corresponds to the ratio of the volume of the voids to the volume of said tread pattern elements (MA, MB, MC). The area voids ratio associated with a tread pattern element (MA, MB, MC) is defined equivalently. By extrapolation, the overall volumetric voids ratio TEV corresponds to the ratio of the voids volume VE to the total volume VT of the tread, such that TEV=VE/VT. The overall volumetric voids ratio TEV for the tread of a tire of the invention is comprised between [20%; 40%], and preferably between [20%; 35%].

The inventors defined the sipe density of the tread pattern elements as being the ratio between the sum of the projected lengths (Lpx) of the sipes of a tread pattern element (MA, MB, MC) along a circumferential direction to the product of the pitch (PA, PB, PC) of the tread pattern element and the width (W) of the tread, the whole being multiplied by 1000, such that:

$$SDA = \frac{{\sum }_{i = 1}^{NA} Lpxi}{PA * W} * 1000 , SDB = \frac{{\sum }_{i = 1}^{NB} Lpxi}{PB * W} * 1000 , et SDC = \frac{{\sum }_{i = 1}^{NC} Lpxi}{PC * W} * 1000$$

with (NA, NB, NC) being the number of sipes of each tread pattern element (MA, MB, MC), and Lpxi being the projected length of the ith sipe of the tread pattern element considered.

According to the inventors, in the definition of (SDA, SDB, SDC), the denominator corresponds to the area encompassing a tread pattern element (MA, MB, MC), so that the sipe density represents the quantity of edge corners of a tread pattern element (MA, MB, MC) over the encompassing area. The higher the density, the more sipes the tire tread comprises and, therefore, the better its grip performance on wet and snow-covered ground.

The sipe density (SDA, SDB, SDC) of each tread pattern element (MA, MB, MC) is at least equal to 10 mm⁻¹, and at most equal to 70 mm⁻¹.

From the sipe densities of the tread pattern elements, the mean sipe density can be deduced:

$$SDmoy = \frac{SDA * NA * PA + SDB * NB * PB + SDC * NC * PC}{NA * PA + NB * PB + NC * PC}$$

By construction, the mean sipe density SDmean is at least equal to 10 mm⁻¹ and at most equal to 70 mm⁻¹.

FIG. 2-C shows, in addition to the main sipes and voids, other cuts in the tread pattern elements. References 100 and 120 point to V-shaped grooves which are cuts with a width of 2.5 mm, oriented in the circumferential direction. References 110 and 130 are oblique grooves 1 mm wide and 9 mm deep. These cuts contribute to the densities of edge corners seen above, which are decisive for grip performance on wet and/or snow-covered ground.

Also shown in FIG. 2-C is the angle PSI2, which is the angle of a leading face with the axial direction, which equivalently can be measured between the direction of advance of the tire and the direction normal to the leading face.

FIG. 3 shows a simplified extract of a developed view of a tread 10 of the invention, where a succession of tread pattern elements (MA, MB, MC) can be observed according to their pitch (PA, PB, PC). The tread 10 is directional, having a favoured direction of running referenced 25. The equatorial plane (C) of the tread divides it into a first edge side 24D and a second edge side 24G. The tread is in contact at each of its axial ends with a sidewall 60 which extends radially inwardly as far as a bead 35. FIG. 3 also shows the main sipes 85 initiated at a first edge (24G, 24D) of the tread which extend into main voids 80 from a connection point 90. Said main voids 80 extend as far as a second edge (24G, 24D) of the tread. Between the tread pattern elements (MA, MB, MC), the bottom 40 of the tread can be seen. The tread pattern elements rise radially outwards from the bottom 40 towards the tread surface over a radial height which corresponds to the height of the tread pattern which varies slightly, decreasing from the centre towards the axial ends of the tread.

The term “edges” 24G, 24D of the tread 10 is understood to mean the surfaces delimiting the boundaries between the tread 10 and the sidewalls 60. These two edges 24G, 24D are spaced apart from one another by a value W corresponding to the width of the tread 10.

As regards the material of the tread, its composition is grouped in Table 2 below:

TABLE 2

| | Elastomer | | | | | | |
|---|---|---|---|---|---|---|---|
| | SBR | BR | | | | | |
| | (Stirene | (Butadiene | | | | | |
| | Butadiene | Rubber | Reinforcing | | | | |
| | Rubber) | elastomer) | filler: silica | Antioxidant | Sulfur | Accelerator | Plasticizer |
| Tread | 60 | 40 | 115 | 4.5 | 1.4 | 1.6 | 72.3 |
| compound | | | | | | | |

The tread compound of the tire of the invention used in this example is based on a stirene butadiene elastomer. Plasticizers (reinforcing resin) are incorporated into the composition to facilitate the processability of the compounds. The compound also comprises vulcanization agents, sulfur, an accelerator, and protection agents.

The associated mechanical and viscoelastic properties, measured at 23° C. under a strain amplitude of 10%, are summarized in Table 3:

TABLE 3

| | G′ (MPa) | G″ (MPa) | Tan(δ)max |
|---|---|---|---|
| Tread compound | 1.82 | 0.64 | 0.367 |

The tire of the invention was tested to clearly highlight the performances provided by the invention. The results of these tests are compared with those obtained for a control tire T1.

The tests of longitudinal grip on snow-covered ground, and on wet ground, and the tire noise were carried out in accordance with the stipulations of the regulation UNECE/R117.

For grip performance, the control T1 is that provided for by the regulation UNECE/R117, corresponding to a tire of usual design which comprises a tread pattern without the main features of the invention. Said tread is made of a material suitable for winter use.

The control T2 dimension for the noise test is the 235/65R16 115 R of a usual design as regards the tread.

A result greater than (or respectively less than) 100% signifies an improvement (or respectively a degradation) of the performance in question.

The results obtained are summarized in Table 4 below:

TABLE 4

| | Longitudinal grip - | Longitudinal grip | |
|---|---|---|---|
| | Snow | on wet ground | Tire noise |
| | In accordance with | In accordance with | In accordance with |
| | UNECE/R117 | UNECE/R117 | UNECE/R117 |
| T1 | 100 | 100 | Not applicable |
| T2 | 107 | 105 | 100 |
| P | 110 | 105 | 105 |

The tire of the invention achieves the desired compromise between grip on snow-covered ground/wet ground and tire noise. The sipes and the main voids made it possible to reach the desired level of grip on snow. The tire noise is under control, remaining at a level consistent with the type-testing certification thresholds of regulation R117, and the grip on wet ground benefits from the sipes and main voids, being at a higher level than in the control T.

1. A tire having a tread intended to come into contact with the ground via a tread surface:
the tread comprising raised elements organized into at least a first and a second tread pattern element (MA, MB), at least partially separated from one another by grooves and extending radially outwards from a bottom surface to the tread surface over a radial height H at least equal to 6 mm and at most equal to the radial thickness Hₛᵣₑ of the tread;
each tread pattern element (MA, MB) comprising a first portion (MA1, MB1) arranged on a first side of the equatorial plane (C) passing through the centre of the tread, said first portion (MA1, MB1) extending continuously into a second portion (MA2, MB2) arranged on a second side of the equatorial plane (C);
the tread being obtained by repeating over one revolution of the wheel the first tread pattern element MA formed by a first and a second portion (MA1, MA2) according to a pitch PA, and the second tread pattern element MB formed by a first and a second portion (MB1, MB2) according to a pitch PB, with PA<=PB;
each portion (MA1, MB1; MA2, MB2) being a volumetric element having leading faces which are the faces of which a radially outer edge corner enters the contact patch first when the tire passes over the ground;
PS12 being the angle formed by each leading face of a portion with an axial direction, defined by the axis of rotation of the tire, PS12 being comprised in the range [0°; 60° ];
each portion (MA1, MB1; MA2, MB2) of each tread pattern element (MA, MB) comprises at least one main sipe having the curvature of said portion, and substantially parallel to its edges, said main sipe extends continuously from a first axial edge from a first side of the equatorial plane (C) to a connection point situated in a main void on a second side of the equatorial plane (C), said main void extending to a second edge of the tread the axial width of said main sipe represents from 52% to 63% of the axial width of the tread; wherein said connection point is situated at a distance normal to the equatorial plane (C) comprised between [0, 25] mm, and wherein the angle PS12 of each leading face of a tread pattern portion is comprised in the range [25°; 60° ] at the axially inner end of the main void.

2. The tire according to claim 1, the tread comprising a third tread pattern element MC formed of two tread pattern portions (MC1, MC2), distributed on either side of the equatorial plane (C), and of pitch PC, with PB less than PC, wherein the ratio of the pitches PB/PC is greater than or equal to the ratio of the pitches PA/PB.

3. The tire according to claim 2, s a wherein each first portion (MA1, MB1, MC1) on a first side of the equatorial plane (C) and each second portion (MA2, MB2, MC2) on a second side of the equatorial plane (C) are curved in an axial direction from an axial end of an edge of the tread to its centre (C).

4. The tire according to claim 2, wherein each first portion (MA1, MB1, MC1) on a first side of the equatorial plane (C) and each second portion (MA2, MB2, MC2) on a second side of the equatorial plane (C) are curved in an axial direction from an axial end of an edge of the tread to its centre (C) so as to give the tread pattern elements (MA1, MA2), (MB1, MB2), (MC1, MC2) a “V” shape (or a chevron shape), thus defining a preferred running direction of the tire in the direction of the “V” tip (or chevron tip).

5. The tire according to claim 2, wherein each first portion (MA1, MB1, MC1) on a first side of the equatorial plane (C) and each second portion (MA2, MB2, MC2) on a second side of the equatorial plane (C) are symmetrical with respect to this same equatorial plane (C).

6. The tire according to claim 1, wherein the ratio of the axial length of a main sipe (85) divided by the axial length of a main void (80) is comprised in the range [1.1; 1.6].

7. The tire according to claim 1, wherein at least one main sipe contains an internal channel buried in the thickness of the tread which is revealed with wear of the tire.

8. The tire according claim 1, wherein the radial depth of a main sipe of a tread pattern element is comprised between 20% and 80% of the maximum radial height of the tread pattern, measured radially from the bottom of the tread pattern.

9. The tire according to claim 1, the width of a main sipe of a tread pattern element is the normal distance between the two walls of said main sipe and wherein the width of a main sipe of a tread pattern portion is comprised between 0.3 mm and 2 m.

10. The tire according to claim 1, wherein the width of a main void of a tread pattern portion is the normal distance between the two walls of said main void, wherein the width of a main void of a tread pattern portion is comprised between 5 mm and 13 mm.

11. The tire according to claim 1, wherein the radial depth of a main void of a tread pattern portion is comprised between 80% and 100% of the maximum radial height of the tread pattern, measured radially from the bottom of the tread pattern.

12. The tire according to claim 1, wherein the overall volumetric voids ratio TEV corresponds to the ratio of the voids volume VE to the total volume VT of the tread, such that TEV=VENT, and wherein the overall volumetric voids ratio TEV of the tread is comprised between [20%, 30%].

13. The tire according to claim 1, wherein the tread forms a ground contact patch AC when said tire is running, and a part of the tread pattern elements which also form a contact surface SC on said contact patch AC determines a surface voids ratio TES of the tread with TES=A_{c}-s_{c}/A_{c}, in which TES is comprised in the range [0.35; 0.5].

14. The tire according to claim 1, wherein the ratio between the pitch PA of the first tread pattern element divided by the pitch PB of the second tread pattern element, PA/PB, is at least equal to 0.60 and at most equal to 0.90.

15. The tire according to claim 1, wherein the tread comprises a third tread pattern element MC of pitch PC, and wherein the maximum pitch of the tread pattern elements (PA, PB, PC) is comprised between 22 mm and 50 mm.

16. The tire according to claim 1, wherein the tread comprises, a third tread pattern element MC of pitch PC, and wherein the volumetric voids ratio TEM of each tread pattern element (MA, MB, MC) is substantially identical.

17. The tire according to claim 1, wherein the composition of the rubber material of the tread has a glass transition temperature Tg comprised of between −40° C. and −10° C. and a complex dynamic shear modulus G* measured at 60° C. is comprised of between 0.5 MPa and 2 MPa.

18. The tire according to claim 1, wherein the tire has a 3PMSF (3 Peaks Mountain Snow Flake) winter certification indicated on at least one of its sidewalls.
